(19) United States
(12) Patent Application Publication
(10) Pub. No.: US 2013/0159711 A1
(43) Pub. Date: Jun. 20, 2013

(54) Communication System and Method

(71) Applicant: Madis Kaal, Tallinn (EE)

(72) Inventor: Madis Kaal, Tallinn (EE)

(21) Appl. No.: 13/363,023

(22) Filed: Jan. 31, 2012

(30) Foreign Application Priority Data
Dec. 15, 2011 (GB) 1121585.2

(51) Int. Cl. H04L 9/28

(52) U.S. Cl. 713/168

(57) ABSTRACT

Data can be transmitted from a user terminal to a decryption component over a network in a limited connectivity environment At the user terminal, the data can be received from a user. If it is determined that the data is sensitive data, the data is encrypted using a secure encryption key. A packet is generated based on a tunneling protocol. The packet includes command data and encrypted sensitive data. The command data includes an address of a network component, command and command identifier. The command identifies that the secure encryption key has been used to encrypt the sensitive data. At the network component identified in the address, the packet is received at a first port; the command is read; the packet is forwarded via a second port to the decryption component for decryption; and a response packet is forwarded, including a response and the command identifier, to the user terminal.

### RELATED APPLICATION

This application claims priority under 35 U.S.C. §119 or 365 to Great Britain Application No. GB 1121585.2, filed Dec. 15, 2011. The entire teachings of the above application are incorporated herein by reference.

### TECHNICAL FIELD

This invention relates to a communication system and method.

### BACKGROUND

Packet-based communication systems allow the user of a device, such as a personal computer, to communicate across a computer network such as the Internet. Packet-based communication systems include voice over interne protocol (“VoIP”) communication systems. These systems are beneficial to the user as they are often of significantly lower cost than fixed line or mobile networks. This may particularly be the case for long-distance communication. To use a VoIP system, the user must install and execute client software on their device. The client software provides the VoIP connections as well as other functions such as registration and authentication. In addition to voice communication, the client may also provide further features such as video calling, instant messaging (“IM”), SMS messaging, and voicemail.

One type of packet-based communication system uses a peer-to-peer (“P2P”) topology built on proprietary protocols. To enable access to a peer-to-peer system, the user must execute P2P client software provided by a P2P software provider on their computer, and register with the P2P system. When the user registers with the P2P system the client software is provided with a digital certificate from a server. Once the client software has been provided with the certificate, communication can subsequently be set up and routed between users of the P2P system without the further use of a server. In particular, the users can establish their own communication routes through the P2P system based on the exchange of one or more digital certificates (or user identity certificates, “UIC”), which enable access to the P2P system. The exchange of the digital certificates between users provides proof of the users' identities and that they are suitably authorized and authenticated in the P2P system. Therefore, the presentation of digital certificates provides trust in the identity of the user. It is therefore a characteristic of peer-to-peer communication that the communication is not routed using a server but directly from end-user to end-user. Further details on such a P2P system are disclosed in WO 2005/009019.

A problem with packet-based communication systems is that a reliable connection to the internet with a sufficient bandwidth is required. Whilst this is generally not a problem when the user is at a known, fixed location (such as their home), this can be particularly problematic when the user is travelling. Wireless internet hotspots, provided by wireless local area network (“WLAN”) access points and appropriate hotspot software, are widely available for use by users when travelling. These are often available in public areas such as airports, cafes and stations. However, these hotspots are frequently not open and access is restricted and secured. These hotspots require the user to obtain login credentials from the hotspot operator in return for payment.

A protocol such as the Wireless Internet Service Provider roaming (“WISPr”) protocol can be used for accessing the hotspot. When the WISPr protocol is used, a user attempting to connect to the internet using a restricted-access hotspot is redirected to a login server of the operator of the hotspot. This redirection results in the display of a login page to the user. The login page prompts the user to either enter a username and password (for example if this has been purchased in advance by the user or provided as part of a pre-arranged billing arrangement) or enter credit card (or other payment) details. By entering the required information the user gains access to the hotspot and can connect to the internet, and is charged accordingly.

Accessing hotspots in such a manner is problematic. Firstly, there is a security issue with the user entering payment details into the login server of the hotspot. The user must have sufficient trust in the hotspot provider not to expose their payment details or personal data. Secondly, it is inconvenient for the users to enter payment details into the hotspot login server, as it requires them to have their payment details to hand. Thirdly, it is a slow process to manually log in and enter this information, which is inefficient if the user wishes to quickly access the internet to use the packet-based communication system.

GB 2464553 addresses some of the aforementioned problems with accessing restricted WLAN hotspots by enabling the users to pay for access to a hotspot using credit that the users have already purchased for use in the packet-based communication system. As the users already use the packet-based communication system, they frequently already have a payment relationship with the provider of the packet-based communication software. Typically, this is in the form of pre-paid credits that the user has purchased, for example for making calls between the internet and the public switched telephone network (“PSTN”).

The users have trust in the provider of packet-based communication software, as they have a pre-existing billing arrangement. Therefore, the users are more comfortable providing personal data or login credentials to the provider of packet-based communication software, rather than the operator of a hotspot.

When using prepaid credit, users do not need to enter payment details whenever they want to access a hotspot. Instead, they only need to provide their login credentials for the packet-based communication network due to the pre-existing billing relationship. The mechanism for accessing the hotspot can be closely integrated into the communication client software, which can greatly speed up the process of the user gaining access to the packet-based communication system via the hotspot.

However, many users who wish to access a hotspot cannot use the above prepaid credit method because they have no credit on their accounts.

There are several problems with enabling the user to pay for access to a hotspot where prepaid credit has not been obtained in advance. A user cannot obtain credit at the time because Internet access is not yet available, so standard web-based payments methods cannot be used.

There are security issues as the hotspot is not under the control of the provider of packet-based communication software, but is instead operated by a third party. The third party may be a malicious user that has set up a hotspot that looks like a legitimate one, but is only there for a purpose of collecting user credentials and/or payment instrument details. Therefore, it is not appropriate for the third party hotspot operator to be exposed to the login credentials and payment details of the user in the packet-based communication network.

Furthermore, a user is unable to gain access to the internet in order to obtain credit without payment or presenting valid credentials.

### SUMMARY

According to one aspect of the present invention there is provided a method of transmitting data from a user terminal to a decryption component over a communication network in a limited connectivity environment, the method comprising:

at the user terminal:

receiving data from a user at the user terminal;

If it is determined that the data is sensitive data, encrypting the sensitive data using a secure encryption key;

generating a packet in accordance with a tunneling protocol, the packet including command data and the encrypted sensitive data, said command data including an address of a network component, a command and a command identifier wherein the command identifies that the secure encryption key has been used to encrypt the sensitive data; and

the network component identified in the address;

receiving the packet at a first port;

reading the command;

forwarding the packet via a second port to the decryption component for decryption; and

forwarding a response packet including a response and the command identifier to the user terminal.

According to another aspect of the invention there is provided a communication system comprising a decryption component, the decryption component comprising: an input for receiving packets with command data and encrypted sensitive data; a memory holding a secure key; and a processor configured to execute a computer program which uses the secure key to decrypt received packets containing encrypted sensitive data, validate said sensitive data and generate a validation response, and a network component connected to the decryption component and having a memory holding a session key, different from the secure key, and including a processor configured to read command data in each received packet; identify an encryption key from the command data; decrypt packets where the encryption key is the session key and forward to the decryption component packets where the encryption key is the secure key.

The sensitive data can be payment data.

Another aspect of the invention provides a user terminal having a user interface configured to prompt a user to enter at least sensitive data or session data;

a processor configured to execute a computer program which:

receives said data;

determines if it is sensitive data or session data;

encrypts sensitive data with a secure encryption key or session data with a session key;

generates a packet comprising command data and said encrypted data, the command data being in plain text and comprising a command and a command identifier wherein the command identifies whether the secure key or the session key has been used.

The computer program can be a communication client, such as Skype™, which establishes communication events in a communication network. However, the functionality may be implemented as stand-alone payment application, or as a feature of any other related application such as WIFI network manager that is part of an operating system such as Windows™.

By providing the command data in plaint text, in the case where a network component which receives the command cannot decrypt data intended for a decryption component, nevertheless it can determine if the command should be forwarded to a decryption component or not.

A further aspect of the invention provides a network component for use in a communication network comprising:

a first port for exchanging packets with the communication network;

a second port for exchanging packets with a decryption component in a secure environment;

a processor configured to execute a computer program which:

receives a packet from the first port, the packet containing encrypted data and command data including a command and a command identifier;

reads the command and determining whether a secure key or a session key has been used to encrypt the data;

where a session key has been used, decrypts the data and acts on it; and

where a secure key has been used;

forwards the packet to the second port;

transmits a response packet including a response and the command via the first port.

In this context, a secure environment encompasses a limited access environment and/or a credit card processing environment.

Another aspect of the invention is a method of operating a network component in a communication network, the method comprising:

Receiving a packet from a first port of the network component with the communication network, the packet containing encrypted data and command data including a command and a command identifier; reading the command and determining whether a secure key or a session key has been used to encrypt the data, where a session key has been used, decrypting the data and acting on it and where a secure key has been used, forwarding the packet to a second port for exchanging packets with a decryption component and transmitting a response packet including a response and the command identifier via the first port.

The invention also provides a computer program product which when executed by a processor implement the above method.

### BRIEF DESCRIPTION OF THE DRAWINGS

For a better understanding of the present invention and to show how the same may be put into effect, reference will now be made, by way of example, to the following drawings in which:

FIG. 1 shows a packet-based communication system;

FIG. 2 shows a user terminal executing a communication client;

FIG. 3 shows a schematic block diagram of components in the communication system;

FIG. 4 shows a signaling chart for transmitting secure data;

FIG. 4A shows a signaling chart for the process of logging into a WLAN hotspot; and,

FIG. 4B shows a signaling chart for status queries.

### DETAILED DESCRIPTION

As discussed above, embodiments of the present invention are useful to provide a solution to solve a data transport problem in a limited connectivity environment, in particular where access to the Internet has not yet been granted. An access protocol using DNS tunneling to exchange data with backend servers, even before the Internet access is opened is described in GB 2464553. Here, the protocol is extended to carry payment details from the client to the backend servers, so that users can buy credit, and get Internet access via a hotspot.

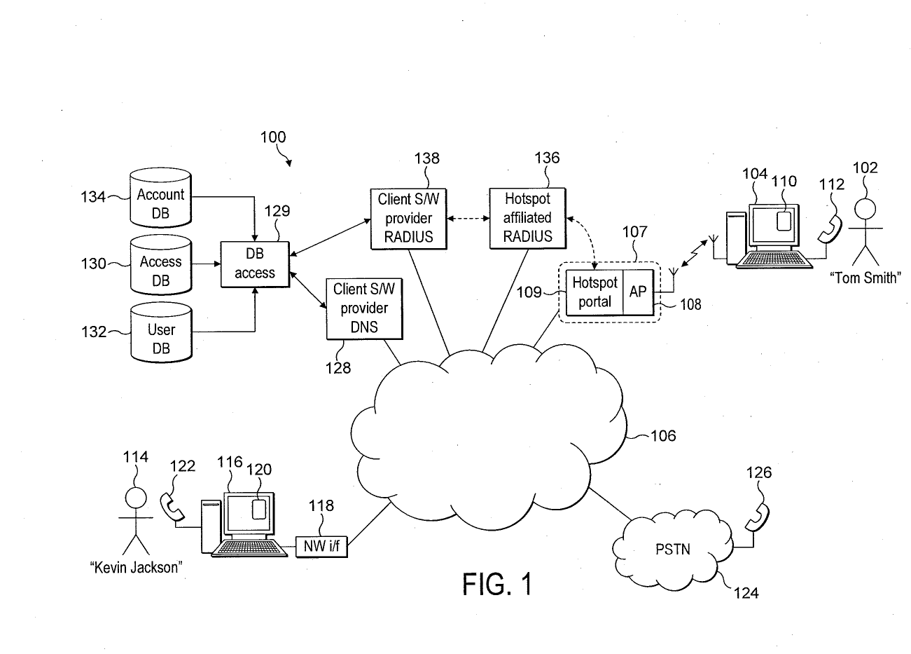

Reference is first made to FIG. 1, which illustrates a packet-based communication system 100. Note that whilst this illustrative embodiment is described with reference to a P2P communication system, other types of communication system could also be used, such as non-P2P, VoIP or IM systems. A first user of the communication system (named “Tom Smith” 102) operates a user terminal 104 which is able to connect to a network 106 such as the Internet. The user terminal 104 may be, for example, a personal computer (“PC”) (including, for example, Windows™, Mac OS™ and Linux™ PCs), a personal digital assistant (“PDA”), a mobile phone, a gaming device or other embedded device able to connect to the network 106. The user terminal 104 is arranged to receive information from and output information to the user 102 of the device. In a preferred embodiment of the invention the user device comprises a display such as a screen and an input device such as a keyboard, mouse, joystick and/or touch-screen.

In the example shown in FIG. 1, the user terminal 104 comprises a network interface that is able to connect to a WLAN access node 107. The access node comprises an access point (“AP”) 108, which provides wireless connections to the access node 107, and a hotspot portal 109, which controls whether a user terminal is able to connect to the access node 107. The AP 108 and hotspot portal 109 can be co-located in a single entity, or be provided in distinct separate entities. However, regardless of the structural layout, the functionality of the two elements is the same, such that the hotspot portal 109 controls whether a user terminal is able to connect to the network 106 (and hence the internet) via the AP 108. The hotspot portal 109 provides functionality such as redirection for authentication and payment.

The user terminal 104 is running a communication client 110, provided by the software provider. The communication client 110 is a software program executed on a local processor in the user terminal 104. The user terminal 104 is also connected to a handset 112, which comprises a speaker and microphone to enable the user to listen and speak in a voice call. The microphone and speaker does not necessarily have to be in the form of a traditional telephone handset, but can be in the form of a headphone or earphone with an integrated microphone, as a separate loudspeaker and microphone independently connected to the user terminal 104, or integrated into the user terminal 104 itself.

Presuming that the user 102 is able to gain access to the network 106 via the WLAN access node 107, VoIP calls to the users in a contact list may be initiated over the communication system by selecting a contact and clicking on a “call” button on a user interface using a pointing device such as a mouse. Referring again to FIG. 1, the call set-up is performed using proprietary protocols, and the route over the network 106 between the calling user and called user is determined by the peer-to-peer system without the use of servers. For example, the first user “Tom Smith” 102 can call a second user “Kevin Jackson” 114.

Following authentication through the presentation of digital certificates (to prove that the users are genuine subscribers of the communication system—described in more detail in WO 2005/009019), the call can be made using VoIP. The client 110 performs the encoding and decoding of VoIP packets. VoIP packets from the user terminal 104 are transmitted into the network 106 via the access node 107, and routed to a computer terminal 116 of the called party 114, via a network interface 118. A client 120 (similar to the client 110) running on the user terminal 116 of the called user 114 decodes the VoIP packets to produce an audio signal that can be heard by the called user using the handset 122. Conversely, when the second user 114 talks into handset 122, the client 120 executed on user terminal 116 encodes the audio signals into VoIP packets and transmits them across the network 106 to the user terminal 104. The client 110 executed on user terminal 104 decodes the VoIP packets, and produces an audio signal that can be heard by the user of the handset 112.

The VoIP packets for calls between users (such as 102 and 114) as described above are passed across the network 106 only, and the public switched telephone network (“PSTN”) 124 is not involved. Furthermore, due to the P2P nature of the system, the actual voice calls between users of the communication system can be made with no central servers being used. This has the advantages that the network scales easily and maintains a high voice quality, and the call can be made free to the users. Additionally, calls can also be made from the client (110, 122) using the packet-based communication system to fixed-line or mobile telephones 126, by routing the call to the PSTN network 124. Similarly, calls from fixed-line or mobile telephones 126 can be made to the packet-based communication system via the PSTN 124.

In addition to making voice calls, the user of the client 110 can also communicate with the users in several other ways, for example, by instant messaging (also known as a chat message), file transmission, sending voicemails to the contacts or establishing video calls.

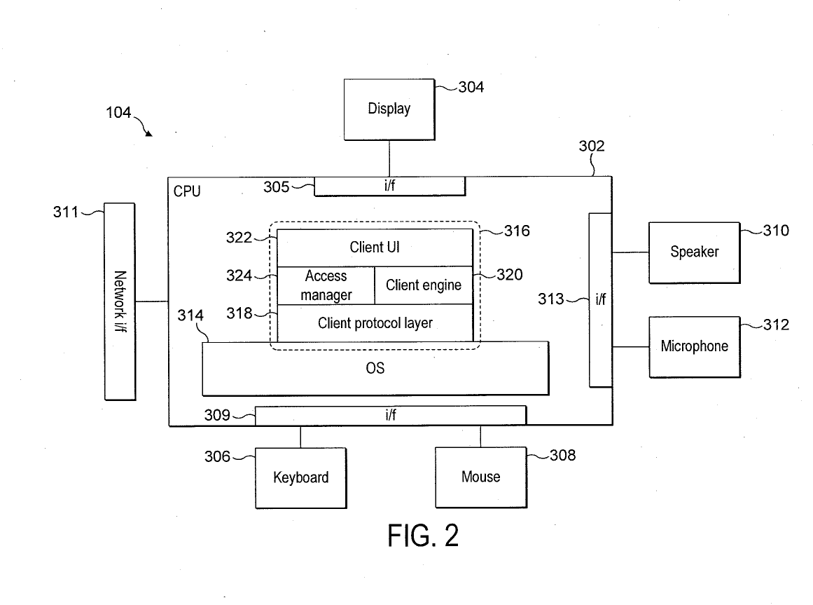

FIG. 2 illustrates a detailed view of the user terminal 104 on which is executed client 110. The user terminal 104 comprises a central processing unit (“CPU”) 302, to which is connected a display 304 such as a screen via a display interface 305, an input device such as a keyboard 306 and a pointing device such as a mouse 308 connected via an interface 309 such as USB. In alternative terminals, the input devices and pointing device can be integrated into the terminal, such as a keypad, touch-screen and/or joystick. An output audio device 310 (e.g. a speaker) and an input audio device 312 (e.g. a microphone) are connected via an audio interface 313. The output audio device 310 and input audio device 312 may be integrated into a handset 112 or headset, or may be separate. The CPU 302 is connected to a network interface 311 for connecting to a WLAN AP.

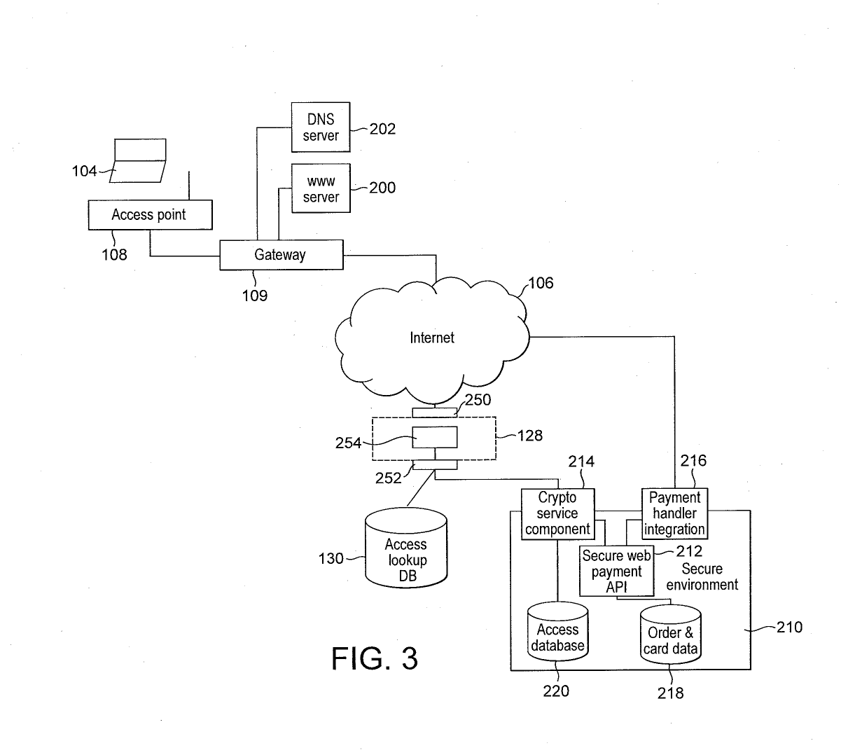

FIG. 2 also illustrates an operating system (“OS”) 314 executed on the CPU 302. Running on top of the OS 314 is a software stack 316 for the client 110. The software stack shows a protocol layer 318, a client engine layer 320 and a client user interface layer (“UI”) 322. Each layer is responsible for specific functions. Because each layer usually communicates with two other layers, they are regarded as being arranged in a stack as shown in FIG. 3. The operating system 314 manages the hardware resources of the computer and handles data being transmitted to and from the network via the network interface 108. The client protocol layer 318 of the client software communicates with the operating system 314 and manages the connections over the communication system. Processes requiring higher level processing are passed to the client engine layer 320. The client engine 320 also communicates with the client user interface layer 322. The client engine 320 may be arranged to control the client user interface layer 322 to present information to the user via the user interface of the client (as shown in FIG. 2) and to receive information from the user via the user interface.

Also shown integrated into the client 110 is an access manager 324. The access manager 324 is responsible for managing access to WLAN hotspots. In preferred embodiments, the access manager 324 is integrated into the client 110, and utilizes the client UI layer 322 to display information to the users, and the client protocol layer 318 to connect to the communication system. In alternative embodiments, the access manager 324 can be implemented as standalone software executed on the OS 314, but which is in communication with the client 110.

FIG. 3 is a schematic block diagram illustrating components of a secure access system for use in the communication system of FIG. 1. Some of the components shown in FIG. 1 are also illustrated in FIG. 2, and are indicated by like reference numerals. In addition to the components shown in FIG. 1, FIG. 2 illustrates a worldwide web server 200 and a domain name server 202 connected to the portal 109.

FIGS. 1 and 3 further illustrate a communication client software provider domain name server (“DNS”) 128. The DNS protocol is used to bypass access restrictions of the hotspot 109 using a technique known as DNS tunneling. Note that the communication client software provider domain server (“DNS”) 128 is not necessarily an actual domain name server, but can be a specially configured backend server that is arranged to communicate using the DNS protocol. Further illustrated in FIGS. 1 and 3 is an access look-up database 130 which can be used to provide access to the hotspot in a manner which is already known from GB 2464553, and briefly described later.

The secure access system shown in FIG. 3 comprises a secure environment, e.g. a payment control industry environment 210 which comprises a cryptoservice component 214, which connects the DNS backend server 128 secure web payment API 212. A payment handler integration service 216 is connected to a database 218 for order and card data which is also connected to the cryptoservice component 214. The cryptoservice component 214 is connected to an access database 220 via the API 212.

The database 220 serves to validate user credentials in the payment process discussed herein.

Credit card number processing has to comply with a set of strict rules for PCI compliance, the main requirement being that the card numbers and other sensitive data must be end-to-end encrypted from client terminal to a PCI compliant environment 210 that is considered secure.

To achieve that new packet types are introduced to extend an access protocol which is used to establish a session (described later). The new packet types carry encrypted payload of sensitive data, in this case payment traffic that the backend server cannot decrypt. The server 128 forwards payment traffic to the cryptoservice component 214.

Security is maintained by using different public key encryption key pairs for encrypting session packets and secure payment packets.

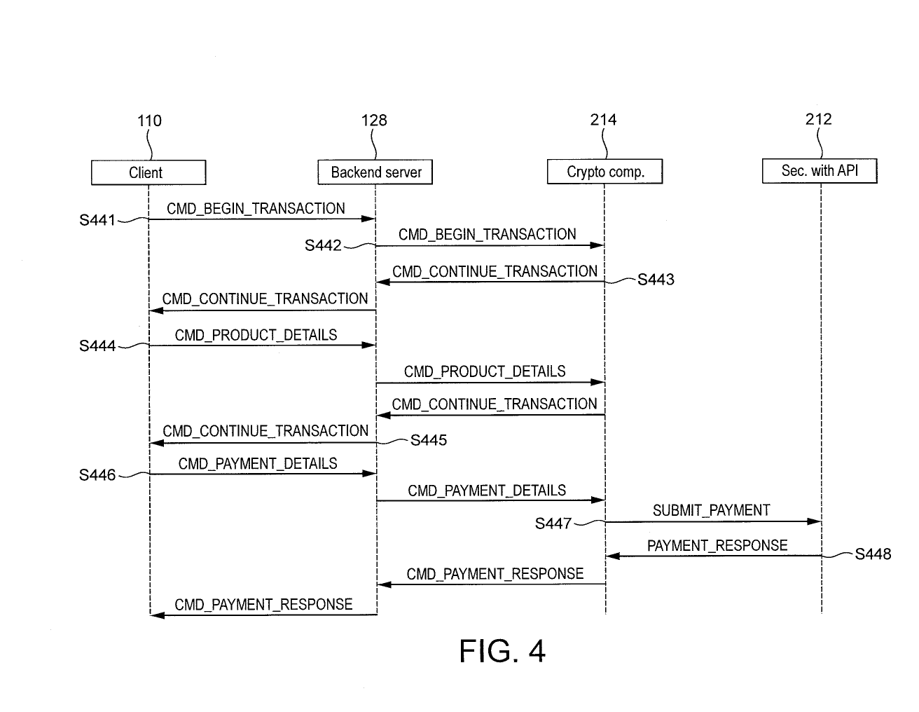

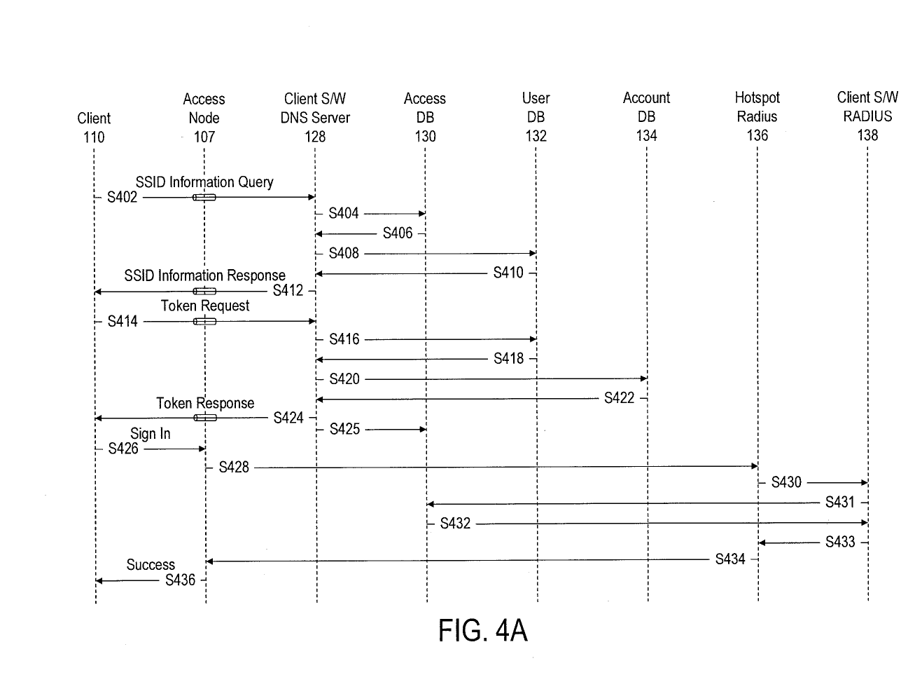

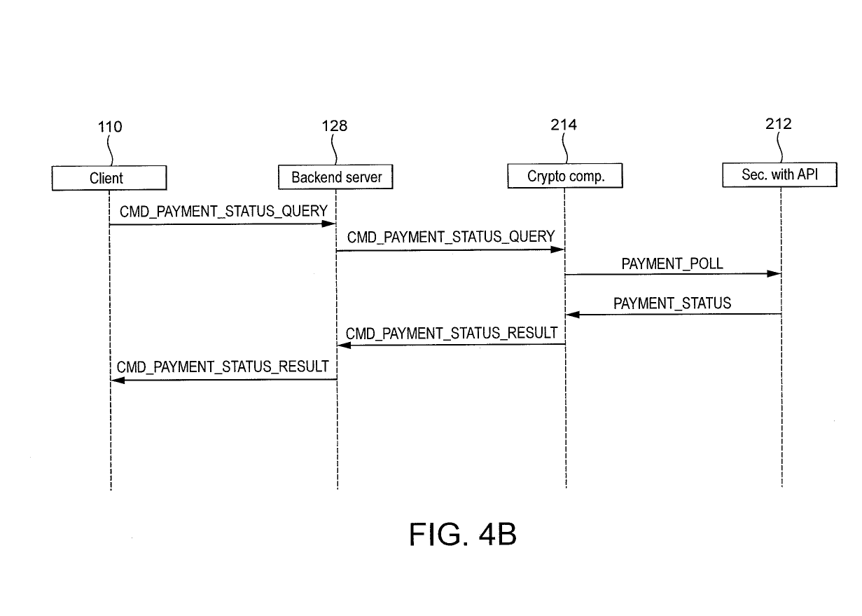

Reference is now made to FIG. 4 which describes the process for effecting a secure communication between the client and the PCI environment by means of which a payment can be made, without having established Internet access.

This payment method is independent from the session establishment process described later with respect of FIG. 4A between Steps S412 and S414.

In the following, the payment messages are encoded as a DNS query that is sent to the communication client software provider domain name server (“DNS”) 128 over the network 106 via a DNS portal of the AP 108. The DNS protocol is used to bypass access restrictions of the hotspot 109 using a technique known as DNS tunneling.

This is achieved by using a Canonical name (“CNAME”) record DNS query. Both the query and response format must comply with strict rules. The total length of a fully qualified domain name (“FDQN”) cannot exceed 255 bytes when represented in internal format that intermixes labels of up to 63 characters with length bytes. Using maximum length labels, there are 250 characters for carrying a payload. Base32 encoding can be used with the dictionary abcdefghjklmnopqrstuvwxyz0123456. Each character can carry 5 bits of binary payload, which means that each response and query can carry 1248 bits. An 1152 bit Rivest Shamir Adleman (“RSA”) key is used for encryption. The readable form of query would be in a similar form to “data.data.data.access.skype.com”. Each DNS tunneling packet has an address identifying the destination of the packet, such as a back end DNS server.

In S441, a begin payment request is sent from the client 110 in terminal 104. The begin payment request is of the following form:

TABLE 1

| field | length | Description |
|---|---|---|
| command | 1 | CMD_BEGINTRANSACTION = 6 |
| cmdid | 1 | client assigned command ID, server will send it |
| | | back in responses to allow matching commands |
| | | and responses |
| challenge | 16 | random client challenge |
| skypename | 32 | string, may be non-zero terminated if skypename |
| | | is exactly 32 characters long |
| pwdhash | 16 | Password hash |

It is noted herein that the reference to “Skyper” and “Skype™” names are not intended to be limiting to the Skype communication system—any username or log-in credentials can be used.

Note that apart from the command and CMD ID fields (which are in plain text), each of the remaining fields in the request are encrypted with a secure RSA private key. The payment RSA private key is a 11552 bit Rivest, Shamir, Adelman key which is used herein exclusively for payment purposes. As described in the following, a different RSA key is used for establishment of sessions. The DNS server 128 has no access to the secure, payment RSA key and so cannot decrypt this request. It forwards it to the cryptoservice component 214. The fact that the secure key has been used is identified by the COMMAND field. In effect, the server 128 treats the encrypted fields as a blob. The server 128 forwards the request to the cryptoservice component 214 over the secure web payment API 212 unchanged as request payload.

The private part of the payment RSA key is only known to the cryptoservice component within the secure environment, and the cryptocomponent uses the private part of the key to authenticate the user. In this embodiment the authentication uses the secure web.api but authentication methods can be different for different user types. A transaction record is created in the database, with a random transaction ID number.

This is noted as S442. The cryptoservice component 214 returns a continue transaction message (S443) of the following form:

TABLE 2

| Field | Length | Description |
|---|---|---|
| command | 1 | CMD_CONTINUETRANSACTION = 7 |
| rc4 | 4 | binary value |
| initialization | | |
| vector | | |
| result code | 1 byte | RESULT_CONTINUE, |
| | | RESULT_NOT_AUTHENTICATED, |
| | | RESULT_INVALID_TRANSACTION, |
| | | RESULT_PAYMENT_FAILED |
| Cmdid | 1 | client assigned command ID, server will |
| | | send it back in responses to allow |
| | | matching commands and responses |
| transaction ID | 16 | |

In the above message, the transaction ID is encrypted with the field containing the RC4 initialization vector, using an RC4 key set to MD5 (client challenge, “encrypt”, initialization_vector). Note that other symmetric encryption algorithms can be used in different implementations for example AES, DES etc. The cmdid field contains the command ID assigned by the client. The result code field holds a response which provides status information to the client. The continue transaction message is returned to the server 128 and then the client 110 which returns a product details message at S444 of the following format:

TABLE 3

| Field | length | Description |
|---|---|---|
| command | 1 | CMD_PRODUCTDETAILS = 8 |
| cmdid | 1 | client assigned command ID, server will send it |
| | | back in responses to allow matching commands |
| | | and responses |
| challenge | 16 | random client challenge |
| transaction ID | 16 | |
| product | 1 | product ID (0 = skype credit, 1 = skype credit |
| | | with auto-topup) |
| amount | 4 | payment amount for currency (uint32 network |
| | | byte order) |
| country | 2 | ISO 2 characters code. Billing country (to |
| | | determine VAT). |

If the product details are accepted, the server 128 responds with a continue transaction message at S445. In the product details message, all fields apart from the command and CMD ID field are encrypted using the payment RSA key. They are thus supplied to the cryptoservice component 214 for decryption and validation.

The continue transaction message is received at the client 104. The payment details are formulated by the client into a payment details message which is transmitted at S416 to the cryptoservice component 214. Note that the entire flow of commands and responses happen after a user has entered all the details in a screen displayed to him in the user interface. The sequence of 3 commands is then automatically issued by the client.

TABLE 4

| field | length | Description |
|---|---|---|
| command | 1 | CMD_PAYMENTDETAILS = 9 |
| cmdid | 1 | client assigned command ID, server will |
| | | send it back in responses to allow |
| | | matching commands and responses |
| challenge | 16 | random client challenge |
| transaction ID | 16 | |
| cardtype | 1 | 0 = unknown, 1 = visa, 2 = mastercard |
| cardnumber | 10 | 19 digits max, BCD encoded, 0xf used for |
| | | padding the end |
| expdate | 2 | MM/YY, BCD encoded, month in first byte, |
| | | year in second |
| cardholder_name | 26 | 0 padded if name length is less than 26 |
| | | characters |
| validationnumber | 2 | 3 or 4 digit validation number. 0xf user |
| | | for padding |

Fields in the payment details message apart from the command and CMD ID field (which are in plain text) are encoded using the payment RSA key. On receiving payment details, the cryptoservice component 214 decrypts the payment details, looks at previously stored data for the transaction based on the transaction ID and generates a request message for the web payment API 212 which uses the PCI database 218 to authenticate the payment. At S448, a payment response is generated by the secure web API 212 which includes a payment ID, preferably in the form of a random number or some other unpredictable parameter. The payment ID is formulated into a payment response by the cryptoservice component 214 and the response is returned to the DNS server 128 and from there back to the client. The format of the payment response is as given below.

TABLE 5

| field | length | Description |
|---|---|---|
| command | 1 | CMD_PAYMENT_RESPONSE = 10 |
| rc4 | 4 | binary value |
| initialization | | |
| vector | | |
| result code | 1 byte | RESULT_INVALID_TRANSACTION, |
| | | RESULT_PAYMENT_PENDING, |
| | | RESULT_PAYMENT_COMPLETED, |
| | | RESULT_PAYMENT_FAILED |
| cmdid | 1 | client assigned command ID, server will |
| | | send it back in responses to allow |
| | | matching commands and responses |
| transaction ID | 16 | |
| payment ID | 16 | order id of SecWeb SubmitPayment |
| | | response, zero terminated C string if |
| | | payment Id len <16 |

Reverting now to the continue transaction message which is provided as a response in S443 to the begin transaction message S442 and in S445 to the product details message. In both of these responses, a result code field can hold one of four possible responses:
RESULT_CONTINUE
RESULT_NOT_AUTHENTICATED
RESULT_INVALID_TRANSACTION
RESULT_PAYMENT_FAILED

In most cases, these result options are supplied to the DNS server by the cryptoservice component 214 depending on the results of the decryption and authentication. However, the network component can generate the fourth result option (RESULT_PAYMENT_FAILED) itself if the cryptoservice component 214 fails to respond. The DNS server generates a message having the format given in Table 2 with the command code, RC4 initialization vector code, command ID and result code sent back in plain text. As there is no transaction ID, there is no need for any part of the payload to be encrypted. Also, as no part is encrypted, the RC4 initialization vector code is not relevant.

Once a client has a payment ID (provided in the payment response message generated in S448), it can poll for payment status using a payment status query message having the format given below (see FIG. 4B).

TABLE 6

| field | length | description |
|---|---|---|
| command | 1 | CMD_PAYMENT_STATUS_QUERY = 11 |
| cmdid | 1 | client assigned command ID, server will send it |
| | | back in responses to allow matching commands |
| | | and responses |
| challenge | 16 | random client challenge |
| skypename | 32 | string, may be non-zero terminated if skypename |
| | | is exactly 32 characters long |
| pwdhash | 16 | Password hash |
| payment ID | 16 | |

The status query message is supplied to the DNS server 128 which passes it to the cryptoservice component 214 for decryption. The cryptoservice component 214 uses the secure web payment API to access the PCI database 218 and ascertain the status of the payment. A payment status is returned by the secure web API 212 back to the cryptoservice component 214 which generates a payment status result message having a format as set out below which is conveyed from the DNS server 128 to the client 110 at terminal 104.

TABLE 7

| Field | length | description |
|---|---|---|
| Command | 1 | CMD_PAYMENT_STATUS_RESPONSE = 12 |
| rc4 | 4 | binary value |
| initialization | | |
| vector | | |
| result code | 1 byte | RESULT_PAYMENT_COMPLETED, |
| | | RESULT_INVALID_PAYMENT, |
| | | RESULT_PAYMENT_FAILED, |
| | | RESULT_PAYMENT_PENDING |
| Cmdid | 1 | client assigned command ID, server will |
| | | send it back in responses to allow |
| | | matching commands and responses |
| payment ID | 16 | |

The above method solves the problem of transporting secure data in a limited connectivity environment. Once payment has been made, a user can receive credit so that they can then access a hotspot with prepaid credit using the technique for example as given in GB 2464553 and described more fully below with respect to FIG. 4A. In the following, the query and response format must also comply with the rules set out for DNS as described above. Furthermore, an RSA key is used for encryption, but this is different than the RSA key which is used for the secure exchange with the cryptoservice component for exchanging payment details. That is, there is a different public key encryption key pair for encrypting packets for access to the DNS server for the purpose of accessing the hot sport using credit, and to the cryptoservice component for the purpose of making payments.

Although the payment flow is independent from session establishment, the method of session establishment is now described. In one embodiment, an SSID request and token request (as described below) is carried out before the user is presented with a payment screen, so the payment command flow follows the steps shown in FIG. 4A, and then the session establishment process is repeated because meanwhile the token would have timed out.

Turning now to FIG. 4A, as a first step (not shown in the Figures), the operating system 314 of the device on which the client is installed scans for available wireless networks. The operating system can automatically connect to a remembered access point or prompt the user to select an access point. The operation of the scanning performed by the OS 314 depends on the user terminal 104 in use, and the OS that it is running.

The access manager 324 (in FIG. 2) detects changes occurring at the network interface 311. This can be achieved either by the access manager 324 being notified of a network interface event or by periodic polling by the access manager. The mechanism used for this depends on the user terminal 104 in question.

When a change in network interface is detected the access manager 324 reads the service set identifier (“SSID”) of the AP 108 found by the OS 314 scan. Responsive to this, the access manager 324 generates an SSID information query. This query is used to discover whether it is possible for the access manager to log in to the hotspot 109 in question, and pay for access using pre-existing payment credits. To do this, the access manager 324 needs to send the SSID information query over the network 106 to a server holding a database of acceptable SSIDs. However, general access to the network 106 is restricted by the hotspot 109. In alternative embodiments, a database of acceptable SSIDs could be kept at the user terminal, but this is more difficult to manage. As the payment messages the SSID information query is encoded as a DNS query.

The SSID information query sent from access manager 324 to the communication client software provider DNS server 128, comprises the SSID identifying the wireless LAN AP 108, a media access control (“MAC”) address (identifying the physical network interface of the AP 108) and optionally the username (Skypename) of the user 102 logged into the client 110.

More specifically, the payload of the SSID information query comprises the following data:
command—1 byte, indicates that the payload is a SSID Information Request
cmdid—1 byte, client-assigned command ID. The DNS server will then send it back in responses to allow matching commands and responses
username—32 bytes, string, may be non-zero-terminated if username is exactly 32 bytes long
access point SSID—32 bytes, string, may be non-zero-terminated if SSID is exactly 32 bytes long
access point MAC—6 bytes, binary, all zeroes if not available
random client challenge—16 bytes, binary
username hash for usernames longer than 32 characters, binary—20 bytes (SHA1) (this is meaningful only if username is not terminated with zero)

The command portion of the payload is sent unencrypted. The remaining payload is RSA encrypted for security. The payload is then base32 encoded, the result is then broken down into separate labels, with a domain name for which the packet-based communication system provider runs a DNS service added, for example “.access.skype.com”.

The access manager 324 in the client 110 then makes a recursive CNAME query. As stated, because this is a DNS query (using DNS tunneling), the message can be sent even though the hotspot 109 restricts access to the network 106.

On receipt of the SSID query the communication client software provider DNS server 128 extracts the binary payload by concatenating all labels and leaving out any characters that are not in the dictionary, until the result is 231 characters long, at which point the base32 encoding is removed, resulting in 144 byte binary payload. The binary payload is then RSA decrypted.

The communication client software provider DNS server 128 determines if an agreement exists between the hotspot 109 operator and a payment partner (i.e. a trusted partner with whom a billing arrangement exists). This is determined by querying an access database 130 with the SSID. A response is received from the access DB 130. Pricing information for this hotspot 109 is also retrieved. The location of the user (set in the user's profile information) can optionally be determined by querying a user database 132 with the username and receiving the response. Using this data, pricing information may be given in the user's local currency.

Note that the databases in FIG. 1 are accessed via an optional DB access node 129.

If the SSID information query does not include the MAC address then the DNS server 128 just looks up the SSID, ignoring the MAC. If the query specifies a certain MAC, then server attempts to find a match. If a match is not found, then server zeroes out MAC address in response, and responds with generic SSID information.

The communication client software provider DNS server 128 generates an SSID response, encoded as a DNS response. If it is determined that the user 102 can pay for access to the interne via the AP 108 using their credit (as purchased for use in the packet-based communication system), the SSID response will indicate that the client 110 can pay for accessing the hotspot using the access manager 324. In particular the SSID response can include pricing information for the hotspot 109 in the user's local currency.

If a user does not have credit, he is shown a pop-up message which indicates he can purchase credit, and the payment procedure of FIG. 4 commences. In one embodiment, the availability of credit is determined by failed token request query, but this information can be provided by other means.

The SSID information response payload generated by the communication client software provider DNS server comprises:
cmdid—1 byte, command ID of SSID request command that this response corresponds to
access point SSID—32 bytes, string, may be non-zero-terminated if SSID is exactly 32 bytes long
access point MAC—6 bytes, binary, all zeroes if not available
price—4 bytes, big endian unsigned integer
price_precision—4 bytes, price decimal precision, big endian unsigned integer
currency—4 bytes, zero terminated 3-letter currency code
provider ID—2 bytes, big-endian integer

The communication client software provider DNS server 128 encrypts the SSID information response using an encryption key derived from the ‘client challenge’ provided in the query. After encryption the payload is base32 encoded.

The SSID information response is sent to the client 110 in step S412 using DNS tunneling.

In response to receiving a positive response to the SSID information query, the access manager 324 is arranged to generate a token request and to transmit the token request using the DNS protocol (tunneling) to the communication client software provider DNS server 128 in step S414.

The payload of the token request message comprises:
command—1 byte
cmdid—1 byte, client-assigned command ID.
username—32 bytes, string, may be non-zero-terminated if username is exactly 32 bytes long
access point SSID—32 bytes, string, may be non-zero-terminated if SSID is exactly 32 bytes long
password hash—16 bytes (MD5), binary
random client challenge—16 bytes, binary
username hash for usernames longer than 32 characters, binary—20 bytes (SHA1) (this is meaningful only if username is not terminated with zero)

The 1-byte command is sent unencrypted, the remaining total payload of 117 bytes is RSA encrypted. The password hash is a username/password hash where additionally first 16 bytes of public RSA key are hashed in. This makes the hash usable only while the RSA key that has been used to encrypt the packet, invalidating all previously sent hash values when the RSA key is invalidated.

The resulting 1160 bits are then base 32 encoded, the result broken down into separate labels, and a domain name for which the packet-based communication system provider runs a DNS service added, for example “.access.skype.com”. The client 110 then makes a recursive CNAME query in IN class to the communication client software provider DNS server 128 in step S414. As each query is different, each reaches the DNS server that gives authoritative answers for a specified domain.

The ‘client challenge’ is used for generating a key for encrypting the response packets, and also for generating a sessionID value from the token (described below). For example, the RC4-drop(768) symmetric encryption algorithm can be used, although any symmetric cipher in stream mode can also be used.

In response to receiving the token request the communication client software provider DNS server is arranged to decrypt the token request and to extract the username and password hash. In step S416 and S418, the DNS server verifies the username and password against credentials listed in the user database 132. In step S420, the user's credit balance is requested from an account DB 134, and a response received in S422, to ensure that the user has sufficient credit to pay for the hotspot 109 access.

If the user is verified and has sufficient credit, then the communication client software provider DNS server 128 will generate a random 16-byte token and respond to the client 110 with a base32-encoded response.

The payload of the token response message comprises:
command—1 byte
rc4 initialization vector—4 bytes, binary value
result code—1 byte
cmdid—1 byte, command ID of token request command that this response corresponds to
token—8 bytes
tick server addresses—8 bytes, preferably two IP addresses of where to send ticks to (described below)
login name format specifier—up to 83 bytes.

The entire payload starting from result code is encrypted using a key generated from the client challenge. After encryption the payload is base32 encoded. The token response message is then sent to the client 110 in step S424 using DNS tunneling. The client 110 then decodes and then decrypts the response.

The communication client software provider DNS server 128 also stores the token that it generated with the username and the client challenge in the access DB 130 in step S425. The communication client software provider DNS server 128 also generates a temporary username from the token (as described below) and stores this as a session ID. The token, if unused, will expire from the server after a predetermined time.

In response to receiving the token and format specifier in step S424, the access manager 324 decodes and decrypts the response. The access manager 324 then controls the client UI 322 to provide the user with the option to pay for connection using their packet-based communication system credit. An example user interface message is shown illustrated in FIG. 5. The user 102 can choose to connect to the AP 108 by selecting the “start” button 502, or choose not to connect by selecting the “cancel” button.

In response to receiving a selection signal from the user indicating that the user wishes to connect to the AP 108, the access manager signs in to the hotspot 109 in step S426 using a temporary username (derived from the token and the client challenge) and a temporary password (derived from a hash function of the user's password and the client challenge).

The temporary username is formatted according to the format specifier included in the token response. The format of the temporary username allows the hotspot 109 provider to determine the identity of the billing partner.

The client 110 signs into the hotspot 109 in accordance with the WISPr recommendations. The access manager 324 attempts to send a http request via the AP 108, for retrieving a predetermined file of known content. The hotspot 109 redirects the request to the hotspot provider's login server (not shown). In response to being redirected to the login server, the access manager 324 is arranged to provide the temporary username and password to sign into the login server.

The hotspot 109 determines from the format of the temporary username (e.g. it has prefix indicating the billing partner) that the login request is associated with the packet-based communication system billing partner and forwards the billing request to the hotspot's Remote Authentication Dial In User Service (“RADIUS”) server 136 in step S428.

In response to receiving the login request at the hotspot RADIUS server 136, the hotspot RADIUS server 136 determines from the format of the temporary user name that the login request is associated with the packet-based communication network. The hotspot RADIUS server 136 sends an authorization query comprising the temporary username and password to the communication client software provider RADIUS server 138 in step S430.

The communication client software provider RADIUS server 138 receives the temporary username and password. Once the communication client software provider RADIUS server 138 has verified the credentials stored in the access DB 130 in steps S431 and S432, it responds to the hotspot RADIUS server 136 in step S433 with an “access accept” or “access reject” message. The “access accept” message identifies the session using the temporary username and can define the length of allowed session time calculated from the minimum of 30 min or the credit divided by the cost per minute. Assuming an “access accept” message was received, the hotspot RADIUS server 136 transmits an authorization message to the hotspot 109 in step S434. In response to receiving the authorization message, the hotspot 109 allows the client 110 to access the internet, and informs client 110 that login was successful in step S436.

The access manager 324 informs (other elements of) the client 110 that login was successful. During the connection with the AP 108, the access manager 324 controls the client 322 UI to inform the user that the terminal is connected to the network.

In the above description, payment packets follow the same pattern as session creation packets, with few important differences:
Different RSA key is used
In addition to command, cmdid is also sent in plaintext
The response may arrive with only command, cmdid, and result code fields filled if crypto component does not respond

The password hash uses the same hashing scheme that is used in token requests. Password hash will be the double-hashed username/Skyper/password hash where additionally first 16 bytes of public RSA key are hashed in. This makes the hash usable only while the RSA key that has been used is valid.

As with other requests, in payment messages the command code, initialization vector, command ID, and result code are sent back in plaintext, while the rest of the response is encrypted.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method of transmitting data from a user terminal to a decryption component over a communication network in a limited connectivity environment, the method comprising:
at the user terminal:
receiving data from a user at the user terminal;
if it is determined that the data is sensitive data, encrypting the sensitive data using a secure encryption key;
generating a packet in accordance with a tunneling protocol, the packet including an address of a network component, command data and the encrypted sensitive data, said command data including a command and a command identifier wherein the command identifies that the secure encryption key has been used to encrypt the sensitive data; and
at the network component identified in the address:
receiving the packet at a first port;
identifying that the packet is in accordance with tunneling protocol;
reading the command;
forwarding the packet via a second port to the decryption component for decryption; and
forwarding a response packet including a response and the command identifier to the user terminal.

2. A method according to claim 1, wherein if it is determined that the data is session data, the session data is encrypted using a session encryption key, and the command identifies that the session encryption key has been used to encrypt the session data.

3. A method according to claim 1, wherein session data encrypted using the session encryption key is decrypted at the network component.

4. A method according to claim 1, wherein the response which is included in the response packet is received from the decryption component by the network component.

5. A method according to claim 1, wherein the response included in the response packet is generated by the network component.

6. A method according to claim 5, wherein the response is generated by the network component when no response is generated by the decryption component.

7. A method according to claim 1, wherein the secure encryption key is one of a key pair, of which the paired key is held at the decryption component and is not known to the network component.

8. A method according to claim 2, wherein the session encryption key is one of a key pair of which the paired key is held at the network component.

9. A method according to claim 1, wherein the command data is in plain text.

10. A method according to claim 1, wherein the sensitive data comprises access data or payment data.

11. A communication system comprising:
a decryption component, the decryption component comprising:
an input for receiving packets with command data and encrypted sensitive data;
a memory holding a secure key; and
a processor configured to execute a computer program which:
uses the secure key to decrypt received packets containing encrypted sensitive data, validate said sensitive data and generate a validation response, and
a network component connected to the decryption component and having a memory holding a session key, different from the secure key, and including a processor configured to read command data in each received packet; identify an encryption key from the command data; decrypt packets where the encryption key is the session key and forward to the decryption component packets where the encryption key is the secure key.

12. A user terminal having a user interface configured to prompt a user to enter at least secure data or session data;
a processor configured to execute a computer program which:
receives said data;
determines if it is secure data or session data;
encrypts secure data with a secure encryption key or session data with a session key;
generates a packet comprising command data in plain text and said encrypted data, the command data comprising a command and a command identifier wherein the command identifies whether the secure key or the session key has been used.

13. A user terminal according to claim 12 wherein the processor is configured to generate the packet in accordance with a tunneling protocol, the packet including an address identifying a network component.

14. A network component for use in a communication network comprising:
a first port for exchanging packets with the communication network;
a second port for exchanging packets with a decryption component in a secure environment,
a processor configured to execute a computer program which:
receives a packet from the first port, the packet containing encrypted data and command data including a command and a command identifier;
reads the command and determining whether a secure key or a session key has been used to encrypt the data;
where a session key has been used, decrypting the data and acting on it; and
where a secure key has been used, forwards the packet to the second port, and transmits a response packet including a response and the command identifier via the first port.

15. A network component according to claim 14 wherein the processor is configured to receive a response from a decryption component and to include the received response in the response packet.

16. A network component according to claim 14 wherein the processor is configured to generate a response packet including a response generated by the network component.

17. A network component according to claim 16 wherein the processor is configured to generate the response at the network component when no response is received from a decryption component.

18. A method of operating a network component in a communication network, the method comprising:
receiving a packet from a first port of the network component with the communication network, the packet containing encrypted data and command data including a command and a command identifier;
reading the command and determining whether a secure key or a session key has been used to encrypt the data;
where a session key has been used, decrypting the data and acting on it; and
where a secure key has been used, forwarding the packet to a second port for exchanging packets with a decryption component and transmitting a response packet including a response and the command identifier via the first port.

19. A computer program product for transmitting data from a user terminal to a decryption component over a communication network in a limited connectivity environment, the computer program product being embodied on a non-transient computer-readable medium and configured so as when executed on one or more processors performs the steps of:
at the user terminal:
receiving data from a user at the user terminal;
if it is determined that the data is sensitive data, encrypting the sensitive data using a secure encryption key;
generating a packet in accordance with a tunneling protocol, the packet including an address of a network component, command data and the encrypted sensitive data, said command data including a command and a command identifier wherein the command identifies that the secure encryption key has been used to encrypt the sensitive data; and
at the network component identified in the address:
receiving the packet at a first port;
identifying that the packet is in accordance with tunneling protocol;
reading the command;
forwarding the packet via a second port to the decryption component for decryption; and
forwarding a response packet including a response and the command identifier to the user terminal.

20. A computer program product for operating a network component in a communication network, the computer program product being embodied on a non-transient computer-readable medium and configured so as when executed on one or more processors performs the steps of:
receiving a packet from a first port of the network component with the communication network, the packet containing encrypted data and command data including a command and a command identifier;
reading the command and determining whether a secure key or a session key has been used to encrypt the data;
where a session key has been used, decrypting the data and acting on it; and
where a secure key has been used, forwarding the packet to a second port for exchanging packets with a decryption component and transmitting a response packet including a response and the command identifier via the first port.
